(19) United States
(12) Patent Application Publication
(10) Pub. No.: US 2004/0250108 A1
(43) Pub. Date: Dec. 9, 2004

(54) Facility monitor

(76) Inventors: Richard Parsons, Phoenix, AZ (US); Deana R. Delp, Tempe, AZ (US)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/486,365

(22) PCT Filed: Aug. 27, 2002
(86) PCT No.: PCT/US02/25949

Related U.S. Application Data
(60) Provisional application No. 60/315,342, filed on Aug. 29, 2001.

(51) Int. Cl. H04L 9/32

(52) U.S. Cl. 713/200

(57) ABSTRACT

The facility monitor (670) is used to monitor and collect measured parameter data and alarm status data for a facility (615), such as a semiconductor processing facility. A graphical user interface (GUI) is used for monitoring the current status (625) and accessing the system history of the facility (645). The GUI provides easily readable screens where the graphical display is organized so that the measured parameter data is logically presented to the user, alarm status data are clearly indicated to the user, and the user can efficiently review the data and respond.

### CROSS-REFERENCE TO RELATED APPLICATION

The present application claims priority to U.S. provisional application serial No. 60/315,342, filed on Aug. 29, 2001, the entire contents of which are herein incorporated by reference.

### BACKGROUND OF THE INVENTION

1. Field of the Invention

The invention relates generally to a method and apparatus for monitoring a local or remote facility (e.g., a facility used in a semiconductor fabrication process). More particularly, the invention relates to a graphical user interface for facility monitoring.

2. Background of the Invention

Maintaining a semiconductor-processing facility is a time consuming and expensive procedure. The inefficient monitoring of a facility can result in facility downtimes that add to the overall operational cost.

Generally, facility control is performed by a number of different control systems having a variety of controllers. Some of the control systems may have man-machine interfaces such as touch panel displays, others may only display readings such as temperature. In addition, facility monitoring is usually time consuming and requires manual entry of data. Facility monitoring also includes recording and responding to problems. Oftentimes, the response time for dealing with problems is lengthened because of a lack of data or lack of personnel trained to respond to a particular problem. This can lead to significant facility down time and the subsequent loss of processing time.

What is needed is an efficient way to monitor a semiconductor-processing facility to reduce facility down times.

### BRIEF SUMMARY OF THE INVENTION

It is an object of the present invention to provide a method and apparatus for monitor a semiconductor-processing facility to reduce facility down times. In one aspect of the invention, a facility monitoring system for monitoring a facility is described wherein the system includes (1) a facility monitor coupled to said facility, said facility monitor receiving monitored parameter data and alarm status data from said facility; (2) a user interface coupled to said facility monitor; and (3) an external interface coupled to said facility monitor.

In one aspect of the invention, the facility monitor further includes memory for storing the monitored parameter data and the alarm status data.

In another aspect of the invention, the user interface includes a first graphical user interface (GUI) providing a facility monitor logger status screen and a plurality of facility monitor logger history screens.

In an additional aspect of the invention, the external interface includes a dial-in service, a paging service, and/or an internet service.

Additional objects and advantages of the invention will be set forth in the description which follows, and in part will be evident from the description, or may be learned by practice of the invention. The objects and advantages of the invention may be realized and obtained by means of the instrumentalities and combinations particularly pointed out hereinafter or by other instrumentalities and combinations.

### BRIEF DESCRIPTION OF THE DRAWINGS

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a simplified block diagram showing a facility monitoring system according to a preferred embodiment of the present invention;

FIG. 2 shows an exemplary view of a Facility Monitor Logger Status Screen and displays information to be selected by a user;

FIG. 3 shows an exemplary view of the monitored status display area of a Facility Monitor Logger Status Screen and displays information to be selected by a user;

FIG. 4 shows an exemplary view of the alarm status display area of a Facility Monitor Logger Status Screen and displays information to be selected by a user;

FIG. 5 shows an exemplary view of a Facility Monitor Logger History Screen displaying a Facility Monitor Logger Graph Display for a process being monitored at a facility;

FIG. 6 illustrates a simplified flow diagram for a method of operating a Facility Monitor Logger GUI in accordance with a preferred embodiment of the invention;

FIG. 7 illustrates a simplified flow diagram for a method of operating a Facility Monitor Logger GUI in accordance with a preferred embodiment of the invention.

FIG. 8 illustrates a computer for implementing either one of a remote facility monitor and a data gathering computer.

### DETAILED DESCRIPTION OF THE INVENTION

Embodiments of the present invention will be described hereinafter with reference to the accompanying drawings. In the following description, the constituent elements having substantially the same function and arrangement are denoted by the same reference numerals, and repetitive descriptions will be made only when necessary.

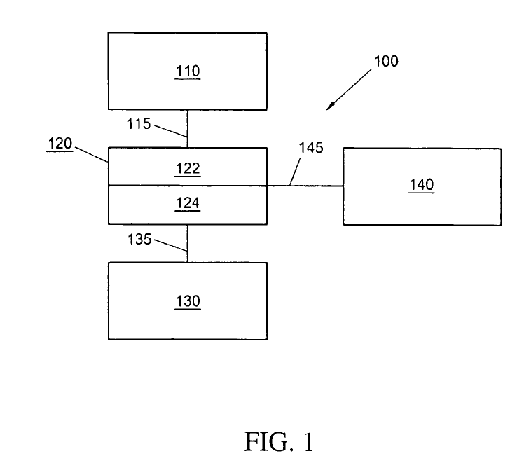

FIG. 1 is a simplified block diagram showing a facility monitoring system according to a preferred embodiment of the present invention. Facility monitoring system 100 includes a facility monitor 120, a user interface 130, and an external interface 140.

Facility monitoring system 100 is coupled to facility 110. Facility monitor 120 is coupled to facility 110, user interface 130, and external interface 140. Facility monitor 120 includes software and hardware means for communicating 115 with facility 110, for communicating 135 with user interface 130, and for communicating 145 with external interface 140.

In a preferred embodiment, system components communicate with each other using TCP/IP compatible networks. The data passed over the TCP/ IP compatible networks is encrypted and uniquely identified. For example, TCP/IP compatible networks can include an intranet, a virtual private network (VPN), and the internet.

In a preferred embodiment, facility 110 includes a plurality of sensors and alarms located throughout facility 110. Exemplary sensors include facility indicators (not shown), scrubber indicators (not shown), gas system sensors (not shown), processing tool sensors (not shown), and alarm indicators (not shown). Facility 110 provides monitored parameter data and alarm status data to facility monitor 120. In an alternate embodiment, facility monitor can provide additional measured data.

Facility monitor 120 includes hardware and software elements (not shown) for monitoring and storing the monitored parameter data and alarm status data from facility 110. The monitored parameter data provides facility readings for facility 110 and system status for the systems (not shown) in facility 110. For example, the hardware can include a computer, memory, video display, mouse and keyboard, and the software can include an operating system.

Facility monitor 120 also includes a database (not shown) for collecting the monitored parameter data and alarm status data. In a preferred embodiment, the database is a Structured Query Language (SQL) database and additional memory space and/or disk storage is provided for the SQL database.

In a preferred embodiment, facility monitor 120 comprises facility monitor logger 122 and facility monitor viewer 124. Facility monitor logger 122 and facility monitor viewer 124 comprise computational resources and operational software. Facility monitor logger 122 is coupled to the database and includes software and/or hardware to read from and write to the database. Facility monitor viewer 124 is coupled to the database and comprises means to read from the database.

In a preferred embodiment, facility monitor logger 122 includes software that is installed onto a computer in a network of computational resources. Desirably, the installation of the software on a computer causes an icon to be displayed on the computer's display. For example, double-clicking the icon can cause the software to begin executing. Desirably, a facility monitor logger computer can obtain data from one or more data collection computers.

In a preferred embodiment, facility monitor viewer 124 includes software that is installed onto several computers in a network of computational resources. Desirably, the installation of the software on a computer causes an icon to be displayed on the computer's display. For example, double-clicking the icon can cause the software to begin executing. Desirably, a facility monitor logger computer, acting as a server, sends out updates to other facility monitor viewer computers, acting as monitors. For example, data can be sent every five seconds.

In a preferred embodiment, a splash screen is displayed and the computer's clock is synchronized. In addition, the computer program is coupled to the database . In a preferred embodiment, user interface 130 comprises a display device (e.g., a monitor, a TV or a flat panel display) (not shown in FIG. 1) that provides a graphical user interface (GUI). In addition, user interface 130 comprises input devices (not shown in FIG. 1) (e.g., a mouse and/or a keyboard).

User interface 130 includes a graphical user interface (GUI) on a computer. In a preferred embodiment, the GUI includes a facility monitor logger status screen for monitoring the current status of facility 110 and a plurality of facility monitor logger history screens for accessing the system history of facility 110.

In addition, the GUI includes a facility monitor viewer status screen for monitoring the current status of facility 110 and a plurality of facility monitor viewer history screens for accessing the system history of facility 110. The facility monitor logger status screen also provides a graphical view of the data that is currently being stored.

In a preferred embodiment, the GUI is presented to the user on a video display such as a computer monitor, and the uses interacts with the GUI using an input device such as a keyboard or a mouse.

In a preferred embodiment, external interface means 140 includes a dial-in service, although any other network adapter using an error checking and retransmission protocol (e.g., TCP/LP) can be used. The dial-in service allows a user to access database 130 via a telephone line and provides limited access to the data in database 130. Desirably, the dial-in service requires the user to input an authorization code (e.g., a PIN number or a password) before gaining access. For example, when a correct PIN number has been entered, the caller can hear the current status for the gas system sensors, facility indicators, scrubber indicators, and alarm status.

In alternate embodiments, the PIN numbers can be used to provide different menus to different users. For example, various menus can be used to provide alarm statuses in different formats.

In a preferred embodiment, external interface means 140 includes a one-way paging service. The paging service allows users to be notified via wireless devices having receiving capabilities. For example, a wireless device can be a one-way pager, a cellular phone, or other computing device having a wireless receiver and display. The one-way paging service provides the user with a limited amount of data from database 130 via a wireless connection.

Desirably, a facility manager's pager is sent a first set of messages, a facility engineer's pager is sent a second set of messages, and a facility technician's pager is sent a third set of messages.

In an alternate embodiment, external interface means 140 includes a two-way paging service. The two-way paging service can allow users to be notified via wireless devices having receiving and transmitting capabilities. For example, a wireless device can be a two-way pager, a cellular phone, or other computing device having a wireless receiver, transmitter, user interface, and display. The two-way paging service can provide the user with a limited amount of data from database 130 via a wireless connection and can provide limited access to the data in database 130. Desirably, the two-way paging service would require the user to input a PIN number before gaining access. For example, when a correct PIN number has been entered, the user could receive the current status for the gas system sensors, facility indicators, scrubber indicators, and alarm status. Authorized users may ‘restart’, ‘shutdown’, and EMO the facility.

In alternate embodiments, the PIN numbers can be used to provide different menus to different users. For example, various menus can be used to provide alarm statuses in different formats to different wireless devices.

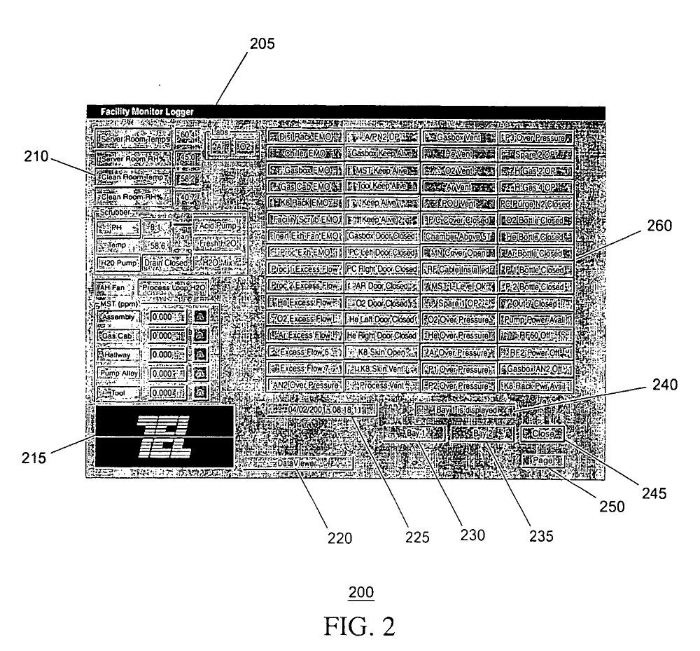

FIG. 2 shows an exemplary view of a Facility Monitor Logger Status Screen and displays information to be selected by a user. Facility Monitor Logger Status Screen 200 includes title bar 205, monitored parameter data display area 210, corporate logo 215, control boxes (220, 230, 235, 240, 245, and 250), time stamp 225, and alarm status display area 260.

As shown in FIG. 2, control boxes include program control box 220, first bay selection button 230, second bay selection button 235, bay selection display 240, close button 245, and page button 250.

Program control box 220 allows a user to select the data viewer software or the data logger software. The name of the software selected is displayed in program control box 220.

First bay selection button 230 and second bay selection button 235 allow a user to select the first bay or the second bay for displaying. The bay selected is displayed in bay selection display 240. Alternately, a combination box or a drop down list can be used for bay selection.

Close button 245 provides a user with a means for closing the GUI screen currently being displayed.

Page button 250 provides a user with a means for sending a page. In a preferred embodiment, a drop-down list of pagers is provided, and the user selects one or more pagers from the list. Pages are sent to the selected pagers.

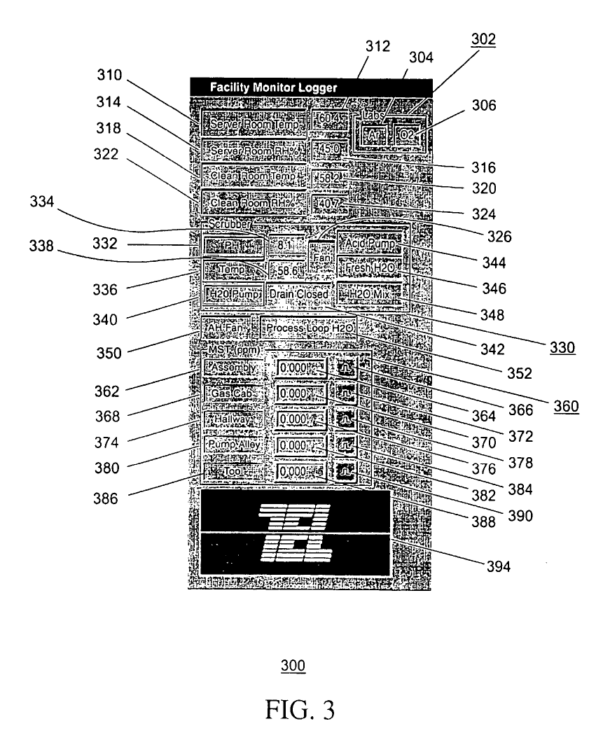

FIG. 3 shows an exemplary view of the monitored status display area of a Facility Monitor Logger Status Screen and displays information to be selected by a user.

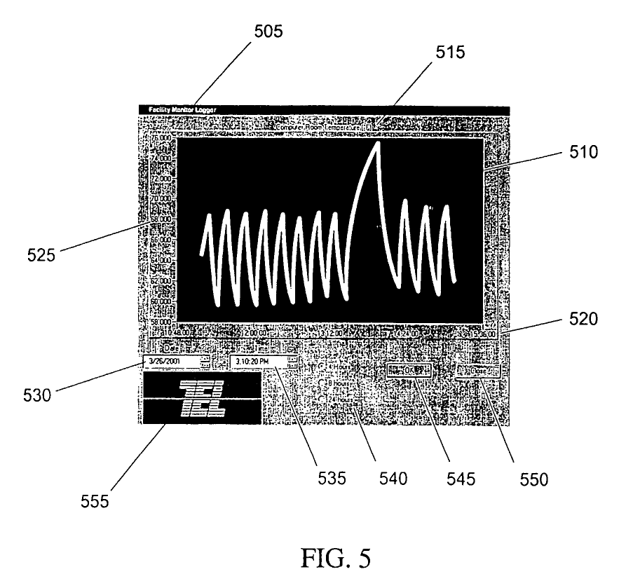

Monitored status display area 300 includes a first display area 302, which includes first status data button 304 and second status data button 306. Activating the first status data button 304 or second status data button 306 causes a Facility Monitor Logger History Screen to be displayed. An exemplary view of a Facility Monitor Logger History Screen is shown in FIG. 5. Can be any monitored parameter vs time, clean room temp is just an example.

As shown in FIG. 3, first display area 302 is labeled “Labs”, first status data button 304 is labeled “Ar”, and second status data button 306 is labeled “O2”. Facility Monitor Logger History Screen includes a Facility Monitor Logger Graph Display for the “Ar” status, when the “Ar” button is double-clicked, or the “O2” status, when the “O2” button is double-clicked.

Monitored status display area 300 further includes a first facility sensor data button 310 and display box 312, second facility sensor data button 314 and display box 316, third facility sensor data button 318 and display box 320, fourth facility sensor data button 322 and display box 324.

In a preferred embodiment, first facility sensor data button 310 is labeled “Server Room Temperature” and display box 312 shows the current value of the Server Room Temperature. Second facility sensor data button 314 is labeled “Server Room RH %” and display box 316 shows the current value of the Server Room relative humidity in percent. In addition, third facility sensor data button 318 is labeled “Clean Room Temperature” and display box 320 shows the current value of the Clean Room Temperature, and fourth facility sensor data button 322 is labeled “Clean Room RH %” and display box 324 shows the current value of the Clean Room relative humidity in percent.

Activating first facility sensor data button 310, second facility sensor data button 314, third facility sensor data button 318, or fourth facility sensor data button 322 causes a Facility Monitor Logger History Screen to be displayed.

In a preferred embodiment, Facility Monitor Logger History Screen includes a Facility Monitor Logger Graph Display for the “Server Room Temperature” status, when the “Server Room Temperature” button is double-clicked, the “Server Room Relative Humidity” status, when the “Server Room Relative Humidity” button is double-clicked, the “Clean Room Temperature” status, when the “Clean Room Temperature” button is double-clicked or the “Clean Room Relative Humidity” status, when the “Clean Room Relative Humidity” button is double-clicked.

Also, monitored status display area 300 further includes a second group 330 of data buttons and display boxes. Second group 330 comprises data button 326, data button 332 and associated display box 334, data button 336 and associated display box 338, data button 340, data button 342, data button 344, data button 346, and data button 348.

As shown in FIG. 3, second group 330 is labeled “Scrubber”. Data button 326 is labeled “Fan” and shows the current operational status for the scrubber fan. The current operational status is shown using colors. Data button 332 is labeled “PH” and associated display box 334 shows the current value of the scrubber PH, data button 336 is labeled “Temp” and associated display box 338 shows the current value of the scrubber temperature. Data button 340 is labeled “H20 Pump”, data button 342 is labeled “Drain Closed”, data button 344 is labeled “Acid Pump”, data button 346 is labeled “Fresh H2O”, and data button 348 is labeled “H2O Mix”.

Activating data button 336, data button 340, data button 342, data button 344, data button 346, or data button 348 causes a Facility Monitor Logger History Screen to be displayed.

In a preferred embodiment, Facility Monitor Logger History Screen includes a Facility Monitor Logger Graph Display for the “Scrubber PH” status, when the “PH” button is double-clicked, the “Scrubber Temperature” status, when the “Temp” button is double-clicked, the “H20 Pump” status, when the “H20 Pump” button is double-clicked, the “Drain” status, when the “Drain Closed” button is double-clicked, the “Acid Pump” status, when the “Acid Pump” button is double-clicked, the “Fresh Water” status, when the “Fresh H2O” button is double-clicked, or the “Fresh Water Mixture” status, when the “H2O Mix” button is double-clicked.

Furthermore, monitored status display area 300 further includes data button 350 and data button 352. As shown in FIG. 3, data button 350 is labeled “AH Fan” and data button 352 is labeled “Process Loop H2O”. Activating data button 350 or data button 352 causes a Facility Monitor Logger History Screen to be displayed. In a preferred embodiment, Facility Monitor Logger History Screen includes a Facility Monitor Logger Graph Display for the “AH Fan, when the “AH Fan” button is double-clicked, or the “Process Loop H2O” status, when the “Process Loop H2O” button is double-clicked.

In addition, monitored status display area 300 further includes a third group 360 of data buttons and display boxes. Third group 360 includes data button 364 and associated display boxes (362, 366), data button 370 and associated display boxes (368, 372), data button 376 and associated display boxes (374, 378), data button 382 and associated display boxes (380, 384), and data button 388 associated display boxes (386, 390). Alternately, display boxes 366, 372, 378, 382, and 390 can be eliminated.

As shown in FIG. 3, third group 360 is labeled “MST [ppm]”. Display box 362 is labeled “Assembly” and associated display box 364 shows the current value of the gas flow rate in the Assembly. Display box 368 is labeled “Gas Cab” and associated display box 370 shows the current value of the gas flow rate in the Gas Cabinet. Display box 374 is labeled “Hallway” and associated display box 376 shows the current value of the gas flow rate in the “Hallway”. Display box 380 is labeled “Pump Alley” and associated display box 382 shows the current value of the gas flow rate in the Pump Alley. Display box 386 is labeled “Tool” and associated display box 388 shows the current value of the gas flow rate in the Tool.

Activating data button 364, data button 370, data button 376, data button 382, or data button 388 causes a Facility Monitor Logger History Screen to be displayed. Alternately, display boxes can be used to cause Facility Monitor Logger History Screens to be displayed.

In a preferred embodiment, Facility Monitor Logger History Screen includes a Facility Monitor Logger Graph Display for the “Assembly gas flow” status, when button 364 is double-clicked, the “Gas Cabinet gas flow” status, when button 370 is double-clicked, the “Hallway gas flow” status, when button 376 is double-clicked, the “Pump Alley gas flow” status, when button 382 is double-clicked, or the “Tool gas flow” status, when button 388 is double-clicked.

In addition, monitored status display area 300 further includes corporate logo display area 394. In an alternate embodiment, a help screen can be displayed when corporate logo display area is double-clicked.

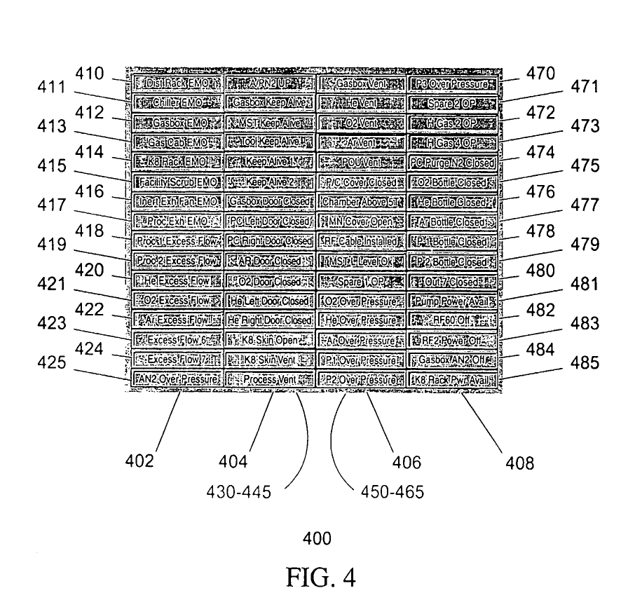

FIG. 4 shows an exemplary view of the alarm status display area of a Facility Monitor Logger Status Screen and displays information to be selected by a user. Alarm status display area 400 includes first display area 402, second display area 404, third display area 406, and fourth display area 408.

First display area 402 includes data buttons 410-425. Selecting any one of data buttons 410-425 causes a corresponding Facility Monitor Logger History Screen to be displayed. In a preferred embodiment, Facility Monitor Logger History Screen includes a Facility Monitor Logger Graph Display for at least one of the processes being monitored in first display area 402.

As shown in FIG. 4, data button 410 is labeled “Dist Rack EMO”, data button 411 is labeled “Chiller EMO”, data button 412 is labeled “Gas Box EMO”, data button 413 is labeled “Gas Cab EMO”, data button 414 is labeled “K8 Rack EMO”, data button 415 is labeled “Facility Scrub EMO”, data button 416 is labeled “Inert Exh Fan EMO”, data button 417 is labeled “Proc Exh EMO”, data button 418 is labeled “Proc 1 Excess Flow”, data button 419 is labeled “Proc 2 Excess Flow”, data button 420 is labeled “He Excess Flow”, data button 421 is labeled “O2 Excess Flow”, data button 422 is labeled “Ar Excess Flow”, data button 423 is labeled “Excess Flow 6”, data button 424 is labeled “Excess Flow 7”, and data button 425 is labeled “AN2 Over Pressure”. Clearly other buttons are possible.

In a preferred embodiment, tile history status of the sensor or equipment corresponding to a button is displayed when the respective button of buttons 410-425 are pressed.

Similarly, second display area 404 includes data buttons 430-435; third display area includes data buttons 450-465; and fourth display area includes data buttons 470-485. Selecting any one of those buttons causes a Facility Monitor Logger History Screen to be displayed for the corresponding sensor or equipment.

FIG. 5 shows an exemplary view of a Facility Monitor Logger History Screen displaying a Facility Monitor Logger Graph Display for a process being monitored at a facility. Facility Monitor Logger History Screen 500 includes a title bar 505, display area 510, monitored value name 515, x-axis 520, y-axis 525, date window 530, time window 535, time selection buttons 540, first operation button 545, second operation button 550, and corporate logo display area 555.

In a preferred embodiment, one screen 500 is displayed at one time. In alternate embodiments, multiple screens can be displayed at one time. For example, multiple screens can be overlaid or paneled.

Display area 510 provides a graphical representation of one of the monitored values over a given time period. For example, monitored temperatures can be graphically displayed as shown in FIG. 5.

Monitored value name 515 provides a description of the monitored value currently being graphically displayed. For example, monitored value name 515 can be Computer Room Temperature as shown in FIG. 5.

X-axis 520 displays time in different manners. Time selection buttons 540 are used to determine the time scale for viewing. In a preferred embodiment, time selection buttons are provided for four hours, eight hours, and twenty-four hours. The selected button is highlighted on the screen. In alternate embodiment, other time selection buttons can be provided.

Y-axis 525 displays a range based on the monitored values to be displayed. For example, when temperature is being displayed Y-axis 525 units are degrees.

Date window 530 displays the day, month, and year for the monitored value currently being graphically displayed. In a preferred embodiment, date window 530 allows dates to be scrolled forward and backward by day.

Time window 535 displays the starting time, using hours, minutes, and seconds, for the monitored value currently being graphically displayed. In a preferred embodiment, time window 535 allows time to be scrolled forward and backward by the time increment selected by one of the time selection buttons 540.

First operation button 545 is used to display a new graph after a new time or a new date is selected. Second operation button 550 is used to return to the Facility Monitor Logger Status Screen.

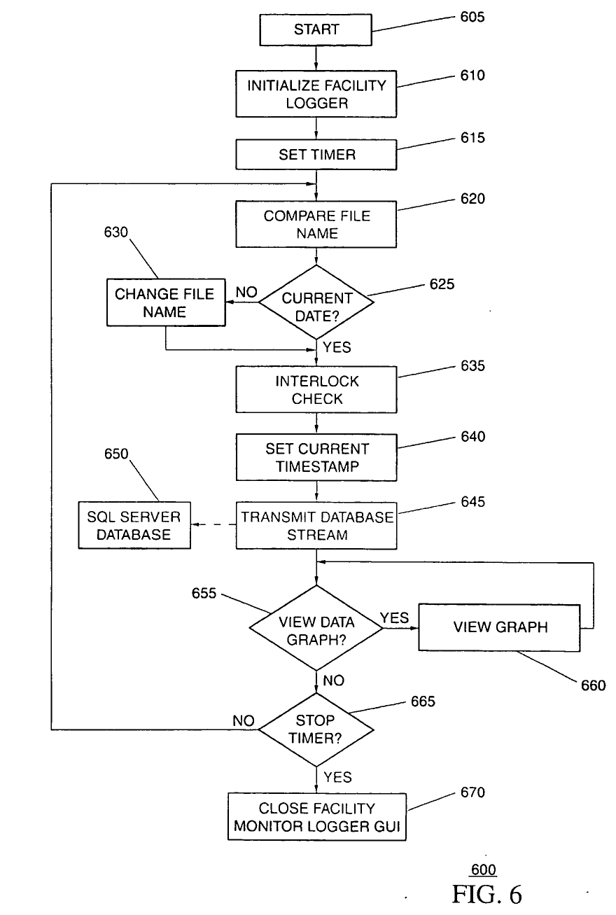

FIG. 6 illustrates a simplified flow diagram for a method of operating a facility monitor logger GUI in accordance with a preferred embodiment of the invention.

Procedure 600 starts in step 605.

In step 610, a facility is determined and the facility monitor logger is initialized. In a preferred embodiment, the facility to be monitored is determined using input data from the user. For example, the user determines that the facility to be monitored is a research laboratory having a specific set of systems to be monitored. The specific set of systems to be monitored arc used to configure the facility monitor logger status screen.

In step 615, a timer is set. In a preferred embodiment, time is synchronized using a global time standard that is accessed via the Internet. Files are saved with a time stamp.

In step 620, the file name is compared. In a preferred embodiment, the file name includes date information that is used to compare files. The comparison determines if the file being accessed has the proper date. If the current file is not the required file then a new file is created with the proper name.

In step 625, a query is performed to determine when the date is current. When the date is current, procedure 600 branches to step 635. When the date is not current, procedure 600 branches to step 630.

In step 630, the file name is changed. In a preferred embodiment, data logger is not allowed to overwrite previously stored data. A new file is created each day.

In step 635, an interlock check is made. In a preferred embodiment, data is obtained for the current status for all of the monitored interlocks and the current status is displayed on the GUI screen.

In step 640, the data file is time stamped. In step 645, the data file is transmitted to the SQL server database. In step 655, a query is performed to determine when to open a graph. When a graph is to be opened, procedure 600 branches to step 660. When the graph is not to be opened, procedure 600 branches to step 665. In a preferred embodiment, a user can elect to view a graph by selecting one of the data buttons being displayed.

In step 660, a graphical display is presented based on the selected data button. In a preferred embodiment, the graphical display can be closed by selecting the “close” button (for example, button 550, FIG. 5).

In step 665, a query is performed to determine when to stop the timer. When the timer is to be stopped, procedure 600 branches to step 670. When the timer is not to be stopped, procedure 600 branches to step 620. In a preferred embodiment, a user can elect to stop the data monitoring process by selecting one of the data buttons being displayed. For example, the user can select the “Close” button.

In step 670, procedure 600 ends and the Facility Monitor Logger GUI is closed.

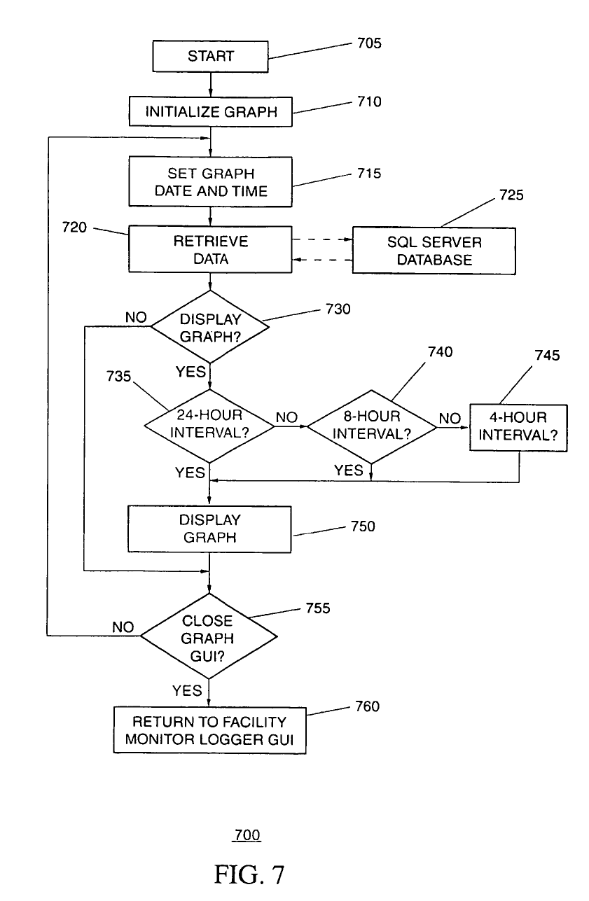

FIG. 7 illustrates a simplified flow diagram for a method of operating a Facility Monitor Logger GUI in accordance with a preferred embodiment of the invention. Procedure 700 starts in step 705.

In step 710, a least one monitored value is determined. In a, preferred embodiment, the monitored value is determined using input data from the Facility Monitor Logger Status Screen. For example, the “Computer Rm Temp” data button has been selected on the Facility Monitor Logger Status Screen. Desirably, a server builds a graph as a JPEG file and sends the file to a viewer.

In step 715, a date and time are determined for the graph. In a preferred embodiment, date and time are initially determined using a system clock and can be changed based on the selected time selection button.

In step 720, data is sent to and retrieved from a SQL server database 725. The graph type, date, and time are sent to the database. Database 725 returns the data for the graph.

In step 730, a query is performed to determine when to display a graph. When at least one graph is to be displayed, procedure 700 branches to step 735. When at least one graph is not to be displayed, procedure 700 branches to step 755. In a preferred embodiment, one or more graphs can be displayed at a particular time.

In step 735, a query is performed to determine when to use a first time period to display a graph. When the first time period is to be used, procedure 700 branches to step 750. When the first time period is not to be used, procedure 700 branches to step 740. In a preferred embodiment, the first time period is a twenty-four hour interval.

In step 745, a third time period is selected, procedure 700 continues to step 750. In a preferred embodiment, the third time period is a four-hour interval.

In step 750, the graph is displayed on the Facility Monitor Logger Status Screen.

In step 755, a query is performed to determine when to close a graph. When a graph is to be closed, procedure 700 branches to step 760. When the graph is not to be closed, procedure 700 branches back to step 715. In a preferred embodiment, a user can select a new date and/or time values.

In step 760, procedure 700 ends, and the Facility Monitor Viewer GUI returns control to the Facility Monitor Logger GUI.

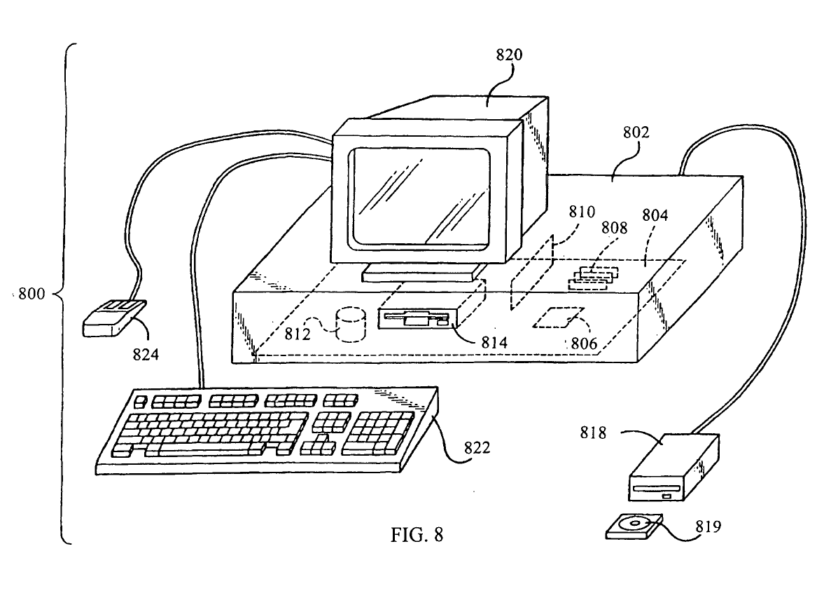

FIG. 8 is a schematic illustration of a computer system for implementing a remote facility monitor. A computer 800 implements the method of the present invention, wherein the computer housing 802 houses a motherboard 804 which contains a CPU 806, memory 808 (e.g., DRAM, ROM, EPROM, EEPROM, SRAM, SDRAM, and Flash RAM), and other optional special purpose logic devices (e.g., ASICs) or configurable logic devices (e.g., GAL and reprogrammable FPGA). The computer 800 also includes plural input devices, (e.g., a keyboard 822 and mouse 824), and a display card 810 for controlling monitor 820. In addition, the computer system 800 further includes a floppy disk drive 814; other removable media devices (e.g., compact disc 819, tape, and removable magneto-optical media (not shown)); and a hard disk 812, or other fixed, high density media drives, connected using an appropriate device bus (e.g., a SCSI bus, an Enhanced IDE bus, or a Ultra DMA bus). Also connected to the same device bus or another device bus, the computer 800 may additionally include a compact disc reader 818, a compact disc reader/writer unit (not shown) or a compact disc jukebox (not shown). Although compact disc 819 is shown in a CD caddy, the compact disc 819 can be inserted directly into CD-ROM drives which do not require caddies. In addition, a printer (not shown) also provides printed listings of process characteristics (either real-time or logged).

As stated above, the system includes at least one computer readable medium. Examples of computer readable media are compact discs 819, hard disks 812, floppy disks, tape, magneto-optical disks, PROMs (EPROM, EEPROM, Flash EPROM), DRAM, SRAM, SDRAM, etc. Stored on any one or on a combination of computer readable media, the present invention includes software for controlling both the hardware of the computer 800 and for enabling the computer 800 to interact with a human user. Such software may include, but is not limited to, device drivers, operating systems and user applications, such as development tools. Such computer readable media further includes the computer program product of the present invention for implementing a remote facility monitor. The computer code devices of the present invention can be any interpreted or executable code mechanism, including but not limited to scripts, interpreters, dynamic link libraries, Java classes, and complete executable programs.

The present invention can be applied to a facility other than a plasma processing facility. Additional advantages and modifications will readily occurs to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. A facility monitoring system for monitoring a facility comprising:
facility monitor coupled to said facility, said facility monitor receiving monitored parameter data and alarm status data from said facility;
user interface coupled to said facility monitor; and
external interface coupled to said facility monitor.

2. The facility monitoring system as claimed in claim 1, wherein said facility monitor further comprises memory for storing said monitored parameter data and said alarm status data.

3. The facility monitoring system as claimed in claim 2, wherein said memory further comprises a structured query language (SQL) server database.

4. The facility monitoring system as claimed in claim 1, wherein said external interface further comprises a dial-in service.

5. The facility monitoring system as claimed in claim 1, wherein said user interface comprises:
first graphical user interface (GUI) comprising a facility monitor logger status screen; and
second GUI comprising a plurality of facility monitor logger history screens.

6. The facility monitoring system as claimed in claim 5, wherein said user interface further comprises a facility monitor viewer, said facility monitor viewer comprising a plurality of facility monitor viewer status screens and a plurality of facility monitor viewer history screens.

7. The facility monitoring system as claimed in claim 5, wherein a facility monitor logger history screen comprises:
display area for displaying a historical value versus a time axis;
a plurality of data buttons for changing the time axis; and
data button for closing said facility monitor logger history screen.

8. The facility monitoring system as claimed in claim 5, wherein said facility monitor logger status screen comprises:
monitored parameter data display area for displaying current values of said monitored parameter data;
program control boxes for sending a page, for closing the facility monitor logger status screen and for selecting a facility monitor viewer status screen; and
alarm status display area for displaying current values of said alarm status data.

9. The facility monitoring system as claimed in claim 9, wherein said facility monitor logger status screen further comprises:
title bar for identifying said facility monitor logger status screen;
corporate logo display area;
time display; and
bay selection display area, for displaying the currently selected bay and allowing a second bay to be selected.

10. The facility monitoring system as claimed in claim 8, wherein said monitored parameter data display area comprises;
display boxes for displaying current values of said monitored parameter data; and
a plurality of monitored data buttons, each monitored data button for activating a facility monitor logger history screen associated with said monitored data button.

11. The facility monitoring system as claimed in claim 8, wherein said alarm status display area comprises a plurality of alarm status data buttons for displaying current values of said alarm status data, each alarm status data button for activating a facility monitor logger history screen associated with said alarm status data button.

12. The facility monitoring system as claimed in claim 8, wherein said program control box for sending a page comprises a drop-down list of people to be paged.

13. The facility monitoring system as claimed in claim 8, wherein said monitored parameter data includes server room monitored data, clean room monitored data, gas supply system monitored data, and processing tool monitored data.

14. The facility monitoring system as claimed in claim 1, wherein said external interface further comprises a paging service.

15. The facility monitoring system as claimed in claim 1, wherein said external interface further comprises a Local Area Network (LAN) terminal, wherein the facility monitor logger status screen and the plurality of facility monitor logger history screens are displayed on another LAN terminal.

16. The facility monitoring system as claimed in claim 1, wherein said external interface further comprises an internet service, wherein said external interface further comprises a terminal connected to the internet, wherein the facility monitor logger status screen and the plurality of facility monitor logger history screens are displayed on another terminal connected through the internet.

17. A method of operating a facility monitor logger, the method comprising;
initializing the facility monitor logger, wherein a facility is determined;
setting a timer, wherein facility monitor logger time is synchronized using a global time standard that is accessed via the Internet;
comparing a file name, wherein the file name comprises date information used to compare files;
determining if the date information is correct;
creating a new file when the date information is not correct, wherein the facility monitor logger is not allowed to overwrite previously stored data;
displaying the current status for monitored parameter data and alarm status data on a facility monitor logger status screen;
creating time stamped data using the monitored parameter data and the alarm status data; and
transmitting the time stamped data to a database.

18. The method as claimed in claim 17, further comprising:
determining when a facility monitor logger history screen has been selected; and
displaying the selected facility monitor logger history screen.

19. The method as claimed in claim 17, further comprising:
determining when the timer has timed-out; and
closing the facility monitor logger when the timer has timed-out.
